(19) United States
(12) Patent Application Publication
(10) Pub. No.: US 2014/0112706 A1
(43) Pub. Date: Apr. 24, 2014

(54) POLE ASSEMBLY

(71) Applicants: HONG FU JIN PRECISION INDUSTRY (SHENZHEN) CO., LTD, Shenzhen (CN); HON HAI PRECISION INDUSTRY CO., LTD., New Taipei (TW)

(72) Inventor: SHI-CHENG MA, Shenzhen (CN)

(73) Assignees: HON HAI PRECISION INDUSTRY CO., LTD., New Taipei (TW); HONG FU JIN PRECISION INDUSTRY (ShenZhen) CO., LTD., ShenZhen (CN)

(21) Appl. No.: 13/690,318

(22) Filed: Nov. 30, 2012

(30) Foreign Application Priority Data
Oct. 23, 2012 (CN) 2012104051889

(51) Int. Cl. F16B 7/00

(52) U.S. Cl. CPC F16B 7/00
USPC 403/186

(57) ABSTRACT

A pole assembly includes four supporting poles spaced from one another, two rails each supported on two adjacent supporting poles, and a mounting apparatus. A number of fasteners are fixed on each of the supporting poles. Each fastener includes a head, a neck portion, and a fixing portion fixed to the supporting pole. The rails are in a row and positioned at a same height of the supporting poles. Each rail defines two locking slots adjacent to opposite ends of the rail. Each locking slot includes an opening and a locking hole communicating with the opening. Each rail is set on two adjacent supporting poles. The neck portions engage in the corresponding locking holes. The adjacent ends of two adjacent rails are fixed to the mounting apparatus.

### BACKGROUND

1. Technical Field

The present disclosure relates to poles and, particularly, to a pole assembly for supporting photovoltaic modules.

2. Description of Related Art

A supporting apparatus for photovoltaic modules may be made by welding a plurality of metal poles together with a non-flexible structure, which results in inconvenient transportation of the supporting apparatus. Another type of supporting apparatus is assembled by a number of poles. The poles are connected to each other by screws. However, it may be inconvenient to assemble the poles.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partially exploded, isometric view of an embodiment of a pole assembly.

FIG. 2 is an enlarged view of a circled part II of FIG. 1.

FIG. 3 is an enlarged view of a fastener of FIG. 2, but an inverted view.

FIG. 4 is an enlarged view of a circled part IV of FIG. 1.

FIG. 5 is an assembled, isometric view of the pole assembly of FIG. 1.

FIG. 6 is an enlarged view of a circled part VI of FIG. 5.

FIG. 7 is an enlarged view of a circled part VII of FIG. 5.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean “at least one.”

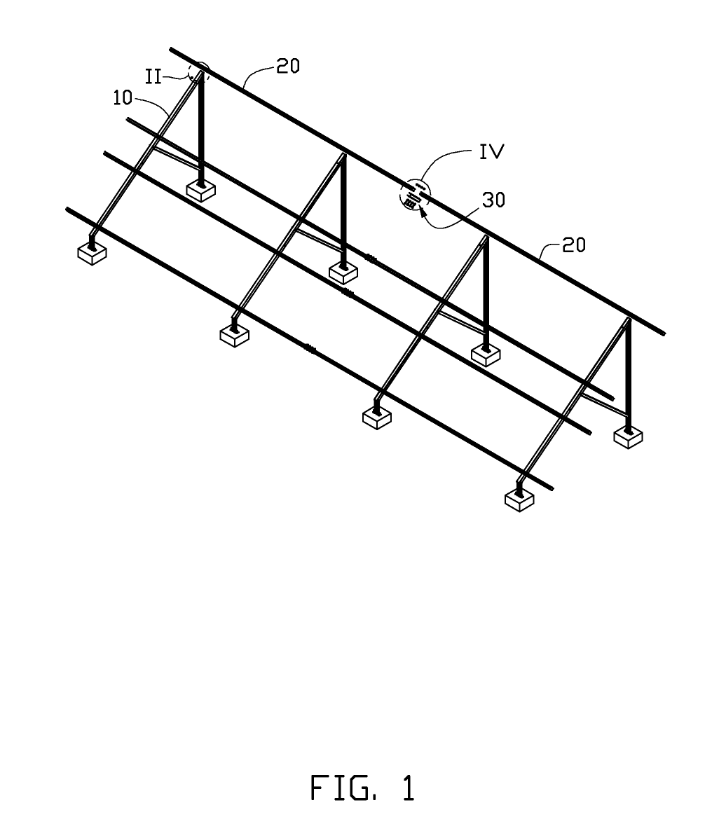

Referring to FIG. 1, an embodiment of a pole assembly includes four supporting poles 10, a plurality of rails 20 supported on the supporting poles 10, and a plurality of mounting apparatus 30. The supporting poles 10 are parallel to one another and angled in relation to the ground. The rails 20 are parallel to one another and perpendicular to the supporting poles 10. Each rail 20 is supported by two adjacent supporting poles 10 and fixed to the same heights of the supporting poles 10. Each two rails 20 fixed to the same heights of the supporting poles 10 are connected by a mounting apparatus 30.

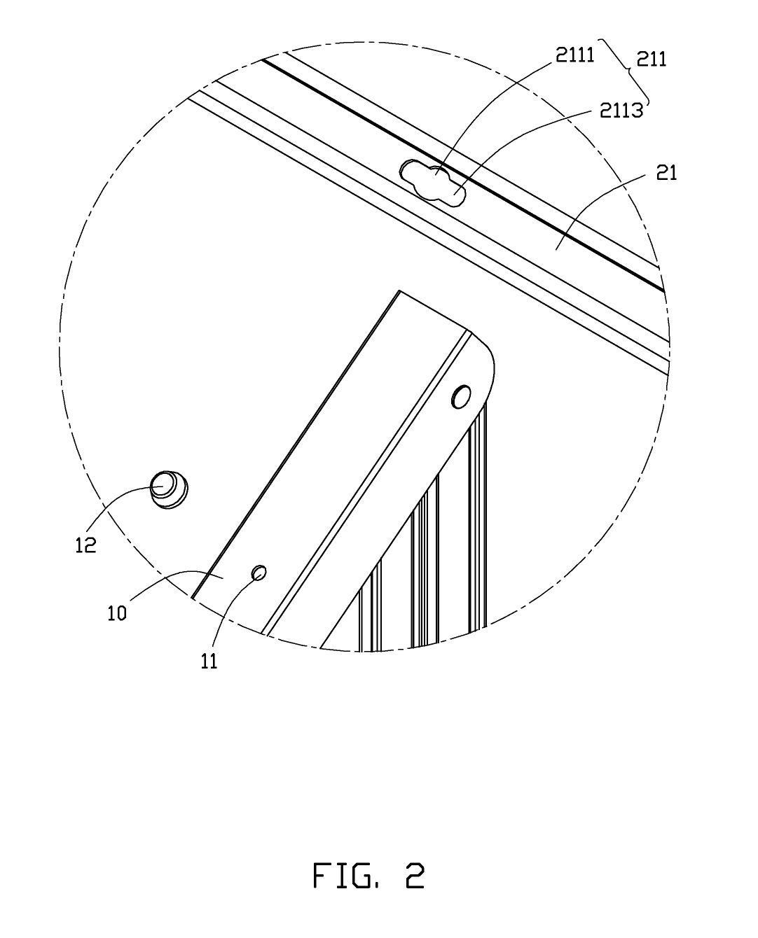

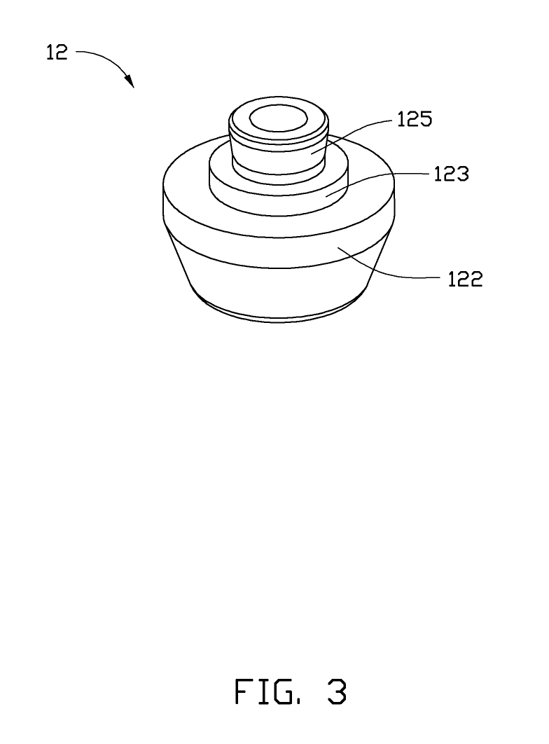

Referring to FIG. 2 and FIG. 3, each supporting pole 10 defines a plurality of fixing holes 11 at different heights. A fastener 12 is fixed to each fixing hole 11. The fastener 12 includes a truncated cone shaped head 122, a neck portion 123 extending down from a bottom of the head 122, and a fixing portion 125 extending down from a bottom of the neck portion 123, opposite to the head 122. The diameter of the head 122 is greater than that the diameter of the neck portion 123. The fixing portion 125 is fixed to the fixing hole 11 by riveting.

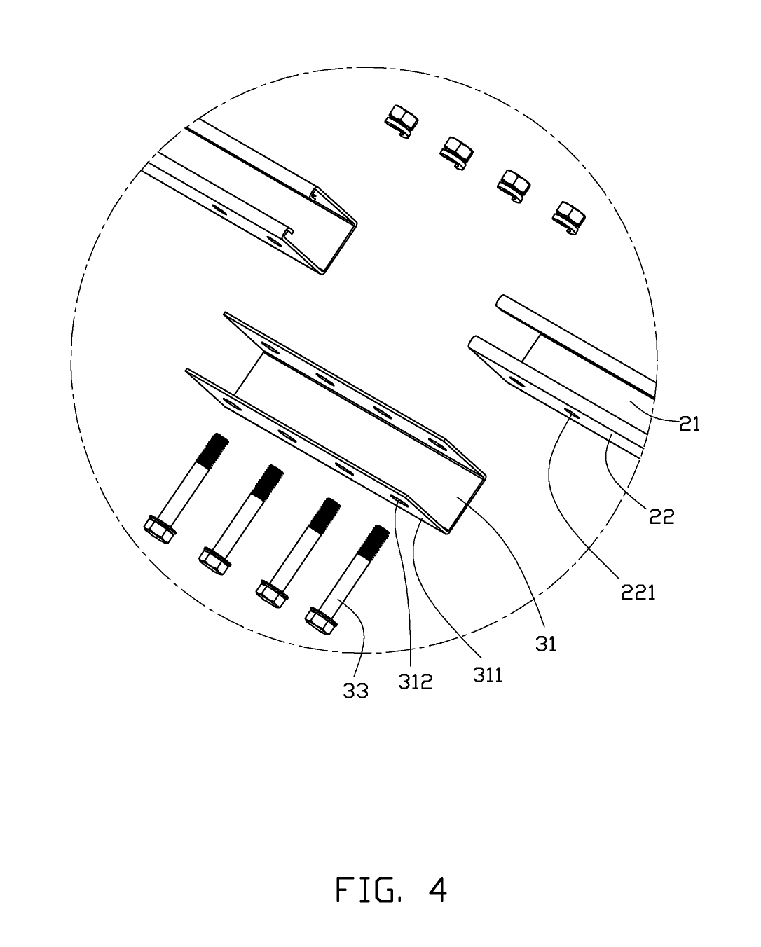

Referring to FIG. 2 and FIG. 4, each rail 20 is U-shaped and includes a bottom wall 21 and two sidewalls 22 extending from opposite sides of the bottom wall 21. The bottom wall 21 defines two locking slots 211 in opposite ends of the bottom wall 21. The distance between the locking slots 211 is equal to a distance between two adjacent supporting poles 10. Each locking slot 211 includes a round opening 2111 and two locking holes 2113, communicating with opposite sides of the opening 2111. The weight of each locking hole 2113 is less than the diameter of the opening 2111. The sidewalls 22 define two opposite through holes 221 in each end of the rail 20.

Each mounting apparatus 30 includes a U-shaped connecting member 31 and a plurality of screws 33. The connecting member 31 includes two parallel side plates 311. The side plates 311 each define a plurality of mounting holes 312.

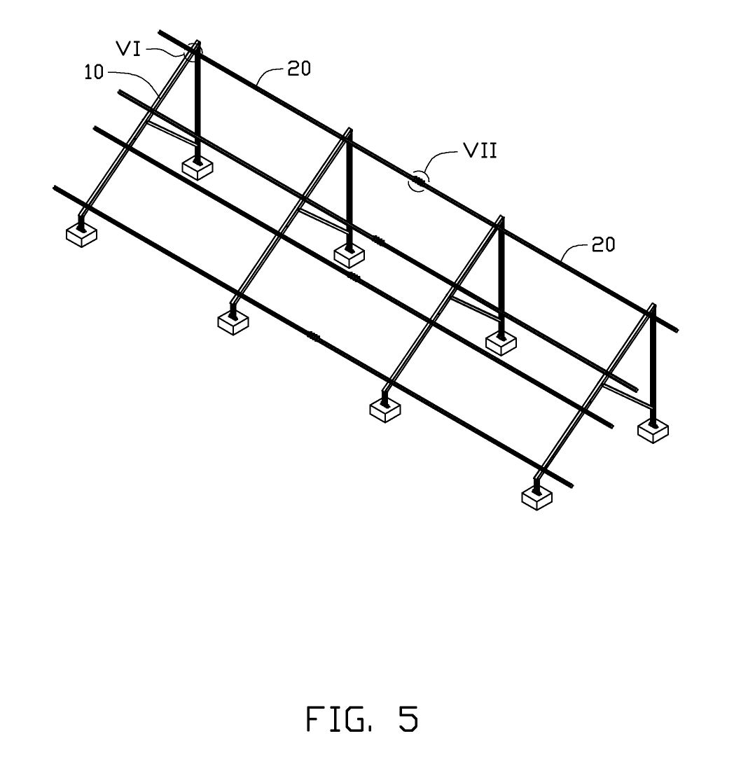

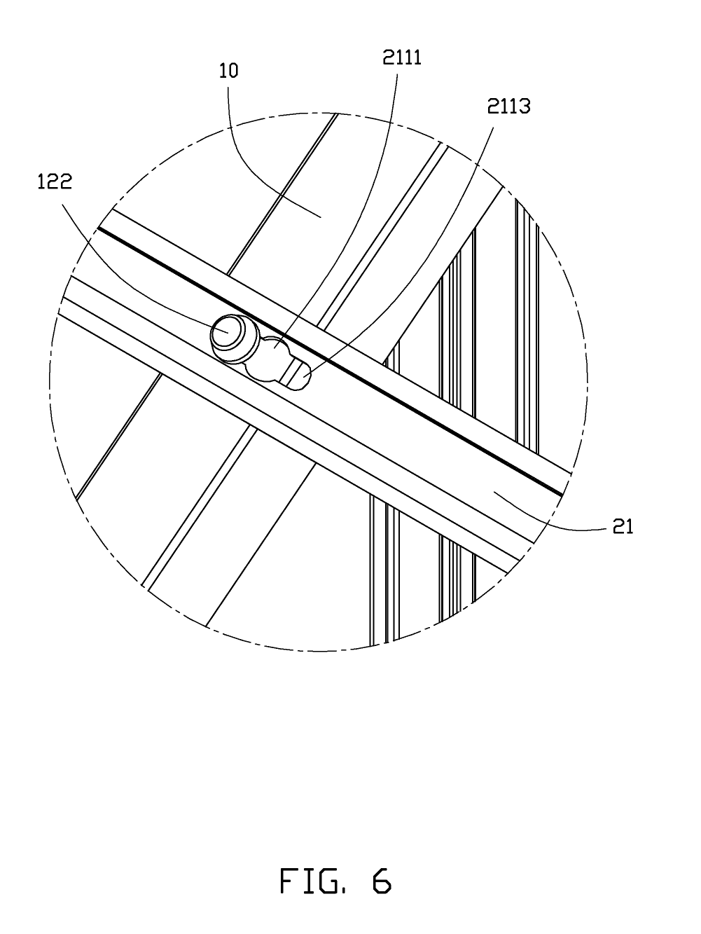

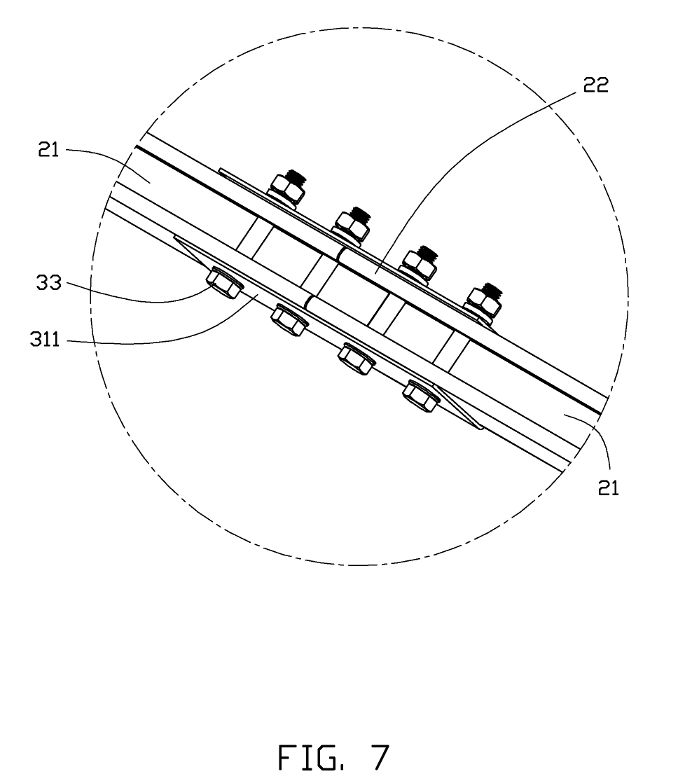

Referring to FIG. 5 to FIG. 7, to mount the rails 20 to the supporting poles 10, each rail 20 is set on two adjacent supporting poles 10, with the locking slots 211 aligning with the fasteners 12. The heads 122 are inserted in the corresponding openings 2111. The rail 20 is then slid toward the corresponding mounting apparatus 30, to make the neck portions 123 engage in the corresponding locking holes 2113 away from the mounting apparatus 30. The heads 122 block a top surface of the rail 20 surrounding the locking holes 2113. The adjacent ends of two rails 20, which are in a row and supported on same heights of the four supporting poles 10, are engaged in the corresponding connecting member 31 between the side plates 311. The screws 33 extend through the mounting holes 312 and the through holes 221 to fix the adjacent ends of the rails 20 to the connecting member 31. Thus, the two rails 20 are assembled on the supporting poles 10.

In one embodiment, the rails 20 are fixed to the supporting poles 10 through fasteners 32 mating with the locking slots 211, which can reduce the quantity of using screws. Furthermore, the position needed for screwing is changed to a space between two supporting poles 10 and not at a junction of the supporting pole 10 and the rails 20, which is easy to operate.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A pole assembly, comprising:
four supporting poles spaced from one another, wherein a plurality of fasteners is fixed on each of the four supporting poles; and each of the plurality of fasteners comprises a head, a neck portion extending down from a bottom of the head, and a fixing portion extending down from a bottom of the neck portion opposite to the head and fixed to one of the four supporting poles;
two rails each supported on two adjacent ones of the four supporting poles, wherein the two rails are in a row and positioned at a same height of the four supporting poles, each of the two rails defines two locking slots adjacent to opposite ends of the corresponding one of the two rails, each of the two locking slots comprises an opening and a locking hole communicating with the opening; and
a mounting apparatus located between the rails;
wherein each of the two rails is set on two adjacent ones of the four supporting poles, with the locking slots aligning with the plurality of fasteners respectively; the heads of the plurality of fasteners are inserted in the corresponding openings, the two rails are then slid toward the mounting apparatus, to make the neck portions engage in the corresponding locking holes, the heads block top surfaces of the two rails surrounding the locking holes, and the adjacent ends of the two rails are fixed to the mounting apparatus.

2. The pole assembly of claim 1, wherein each of the two rails is U-shaped and comprises a bottom wall and two sidewalls extending from opposite sides of the bottom wall, and the two locking slots are defined in the bottom wall.

3. The pole assembly of claim 2, wherein the two sidewalls define two opposite through holes in each end of the rail, the mounting apparatus comprises a U-shaped connecting member and a plurality of screws, the U-shaped connecting member includes two parallel side plates each defining a plurality of mounting holes, the adjacent ends of two rails are engaged in the connecting member between the side plates, and the plurality of screws extends through the plurality of mounting holes of the side plates and the through holes of the two sidewalls to fix the adjacent ends of the rails to the connecting member.

4. The pole assembly of claim 1, wherein the head of each of the fastener is truncated cone shaped.
